(19) United States
(12) Patent Application Publication
(10) Pub. No.: US 2017/0141671 A1
(43) Pub. Date: May 18, 2017

(54) ELECTRIC POWER GENERATING APPARATUS

(71) Applicant: Frank N Stubb LLC, Williamsville, NY (US)

(72) Inventors: Brad Stubbings, Rochester, NY (US); Nicholas Frank, Williamsville, NY (US)

(73) Assignee: Frank N Stubb LLC, Williamsville, NY (US)

(21) Appl. No.: 14/940,900

(22) Filed: Nov. 13, 2015

(51) Int. Cl. H02K 47/00

(52) U.S. Cl. CPC H02K 47/00; Y10S 74/09; H02K 53/00

(57) ABSTRACT

What is presented is an apparatus for providing electrical energy for an extended period of time. The apparatus comprises a battery bank for generating electrical energy, a current-conversion component is electrically connected to the battery bank, a secondary generator, a motor, and the load circuit. The motor is started by the electrical energy generated from the battery bank and converts electrical energy into mechanical energy. A primary generator is mechanically connected to the motor and electrically connected to the battery bank. The primary generator converts the mechanical energy from the motor into electrical energy and provides the electrical energy to the battery bank. The secondary generator is also mechanically connected to the motor and converts the mechanical energy from the motor into electrical energy and provides this energy to the current-conversion component. The current-conversion component provides electrical energy to the motor and provides adapted electrical energy to the load circuit.

### FIELD OF THE INVENTION

This invention relates to an apparatus for generating electrical energy (electric power), and particularly to an electric generating apparatus which produces electric power for an extended period of time without needing replacement of an energy supply, and more particularly to an electric generating circuit that comprises multiple components working synergistically to produce electrical energy for such an extended time period.

### BACKGROUND

Electric generators (“electric power generators”) are machines, or circuits comprising machines working synchronously, which convert one form of energy into electrical energy (electricity) for transmission and distribution purposes. In addition to the underlying need for a public electrical energy, these generators are commonly implemented throughout the world to supply a flow of electrical energy in many different domestic, commercial, and industrial applications. Examples include, but are not limited to, reducing power grid demand to avoid incurring burdensome utility bills, providing a standby electrical power source during electric power grid outages, providing electrical power to industrial power tools and fluid pumps, and powering remote infrastructure when there is no other available power supply. Moreover, portable electric generators may also be adapted to produce the electrical power required for automobiles, aircraft, ships, trains, and various other vehicles.

The source of energy supplied to run these electric generators is typically limited, such as a supply of combustible fossil fuels (e.g. gasoline or diesel). This creates a major limitation on these generators. They may only be used for short-term time periods before their energy supply needs replacement. Even the most fuel-efficient generators are able to go a number of hours before their energy supply runs out. In many cases, the length of time needed for providing electrical power (e.g. a power grid outage) far exceeds the time limitations of these generators or it is simply uneconomical to constantly have to replace their energy supply to keep the electrical power flowing. There therefore exists a need for an electric generating apparatus that can go extensive/extended periods without the need for energy source replacement. Such an apparatus may be desirable for green energy purposes, certain military applications, and to help provide a more economical source of electrical power. What is presented is an electric generating apparatus and circuit, which can each provide electrical energy provided to a load circuit for an extended time period.

### BRIEF DESCRIPTION OF DRAWINGS

For a more complete understanding and appreciation of this invention, and its many advantages, reference will be made to the following detailed description taken in conjunction with the accompanying drawings.

FIG. 1 shows a an embodiment of the electric generating apparatus according to one embodiment of the invention;

FIG. 1A shows a schematic view of the electric generating apparatus of FIG. 1;

FIG. 2 shows another embodiment of the electric generating apparatus;

FIG. 2A shows a schematic view of the electric generating apparatus of FIG. 2; and

FIG. 3 depicts another embodiment of the electric generating apparatus.

Corresponding reference characters indicate corresponding parts throughout the several views. The exemplifications set out herein illustrate currently preferred embodiments of the invention, and such exemplifications are not to be construed as limiting the scope of the invention in any manner.

### SUMMARY

What is presented, briefly described, is an apparatus for providing electrical energy for an extended period of time. The apparatus comprises a battery bank, current-conversion component, motor, primary generator, and secondary generator. The battery bank is for generating a charge of electrical energy. The current-conversion component is configured to be electrically connected at its input to the battery bank and a secondary generator. The current-conversion component is also configured to be electrically connected at its output to a motor and a load circuit. The motor is started by the charge of electrical energy generated from the battery bank and converts electrical energy into mechanical energy. The primary generator is configured to be mechanically connected to the motor and converts mechanical energy from the motor into electrical energy and in turn provides that electrical energy to the battery bank. The secondary generator configured to be mechanically connected to the motor and converts mechanical energy from the motor into electrical energy and in turn provides that electrical energy to the current-conversion component. The current-conversion component is also configured to provide electrical energy to both the motor and the load circuit.

The apparatus may have an additional secondary generator mechanically connected to the motor, which converts mechanical energy from the motor into electrical energy and in turn provides the electrical energy to an additional current-conversion component. The additional current-conversion component may be configured to provide adapted electrical energy to the load circuit. The apparatus may have an additional primary generator mechanically connected to the motor, which converts mechanical energy from the motor into electrical energy and in turn provides the electrical energy back to the battery bank. The apparatus may have a switch to disconnect the flow of electrical energy to the load circuit.

The primary generator and the secondary generator may each be an alternator having a self-exciting stator. The mechanical connection between each generator and the motor may be a pulley and belt configuration. The load circuit may be a vehicle, infrastructure, or a power tool. The battery bank may be at least two deep-cycle batteries electrically connected in a series configuration. The current-conversion component may be an inverter board or it may be a bridge rectifier assembly. The apparatus itself may be portable.

What is also presented, briefly described, is an electrical energy providing circuit that has been configured to provide electrical energy for an extended period of time to a load circuit. The circuit comprises a plurality of deep-cycle batteries electrically connected in a series configuration, an inverter board, motor, switch, primary alternator, and a secondary alternator. The batteries can generate a charge of electrical energy. The inverter board is electrically connected at its input to one of the plurality of batteries and the secondary alternator. The inverter board electrically connected at its output to the motor and load circuit. The motor is started by the charge of electrical energy generated from the plurality of batteries and converts this electrical energy into mechanical energy.

The primary alternator has a self-exciting stator and is mechanically connected to the motor via a pulley and belt configuration. The primary alternator converts mechanical energy from the motor into electrical energy and in turn provides this electrical energy to one of the batteries. The switch can disconnect the flow of electrical energy to the load circuit. The secondary alternator has a self-exciting stator and is mechanically connected to the motor via an additional pulley and belt configuration. The secondary alternator converts mechanical energy from the motor into electrical energy and in turn provides this electrical energy to the inverter board. The inverter board provides electrical energy to the motor and also provides adapted electrical energy to the load circuit. In this embodiment, the load circuit is closed and operates with nominal energy loss through normal operations.

These and other features, aspects and advantages of the present invention will become better understood with reference to the following drawings, description and claims.

### DETAILED DESCRIPTION

Referring to the drawings, some of the reference numerals are used to designate the same or corresponding parts through several of the embodiments and figures shown and described. Corresponding parts are denoted in different embodiments with the addition of lowercase letters. Variations of corresponding parts in form or function that are depicted in the figures are described. It will be understood that variations in the embodiments can generally be interchanged without deviating from the invention.

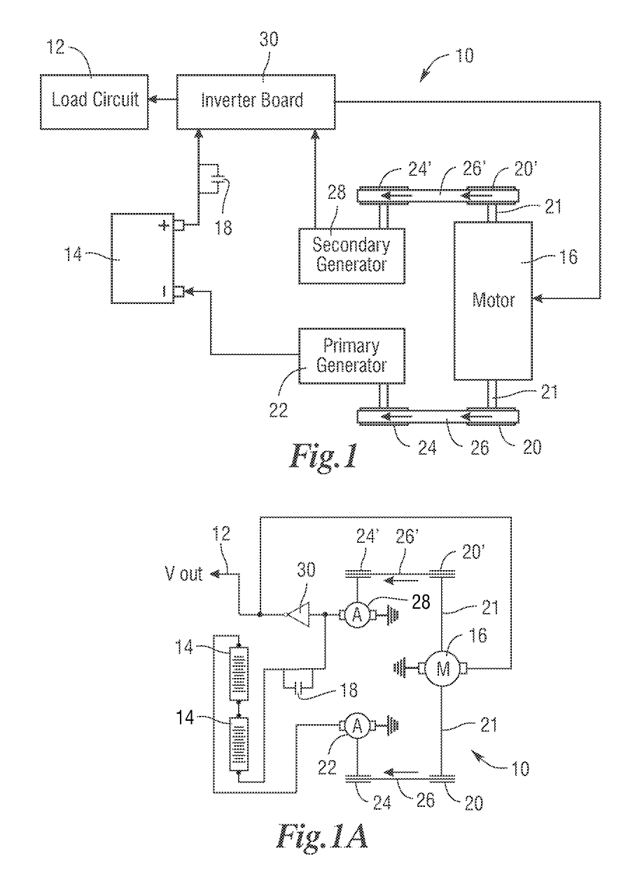

Referring now to FIG. 1, there is seen a circuit schematic of an embodiment of an electricity generating apparatus (apparatus circuit) generally shown as reference numeral 10. When the individual components of this apparatus 10 are in proper connection and functioning in a synchronous manner, the apparatus 10 is able to provide electrical power to a load circuit 12 for an extended period of time without needing the replacement of the energy source. In certain instances, such as when the load circuit 12 does not incur much energy loss, the apparatus 10 is capable of fully operating the load circuit 12 for long time periods before it becomes incapable of providing a sufficient flow of electrical energy. In most cases, the apparatus 10 will simply operate until being turned off or the mechanical breakdown of one of its components.

The apparatus 10 may releasably, electrically connect to the load circuit 12 so as to provide long-term electrical energy (power) to the various load circuit 12 components. The apparatus 10 comprises a battery bank 14 configured to store and release a charge of electrical energy. A current-conversion component 30, which is an inverter board in this embodiment, is electrically connected downstream from the positive terminal (voltage output) of the battery bank 14. At one output, the inverter board 30 is electrically connected to the terminal box (initial circuit) of an electric motor 16. As such, when a user (not shown) begins operation of the apparatus 10, stored chemical energy from the electrochemical cells of the battery bank 12 is converted into a charge of electrical energy released to the inverter board 30. The inverter board 30 in turn funnels the electrical energy through to turn the motor 16 over and begin motor operations. To maintain damage does not occur, one of skill will see the inverter board 30 may be configured to shelter the load circuit 12 from this initial charge of electrical energy.

In this embodiment, the battery bank 14 comprises two deep-cycle batteries electrically connected in a series configuration. However, the battery bank 14 may comprise different types of batteries and/or more than two batteries connected in a series configuration when the circumstances call it (such as when the motor 16 requires the energy needed to provides a substantial amount of horse power (HP)). An example of a deep-cycle battery that may be used in the battery bank 14 would be, but is not limited to, a 12V SPP2150 5000A Series Dry Cell Battery (available from the Stinger Electronics Company). Implementing two (2) 12V batteries in series within the battery bank 14 allows 24V to be produced at its voltage output (positive terminal), adequate to provide a strong enough charge of electrical energy to start motor operations. It should be understood that other types of batteries and/or batteries with stronger or weaker voltages may work when such circumstances call it (such as when the motor 16 requires more/less voltage to start operations). In certain instances, at least one capacitor 18 may be implemented into the design circuit 10 to help boost the electrical energy charge and ensure the start of motor operations (otherwise known as a “booster pack”). This capacitor 18 is typically positioned in parallel with the electrical connection between the battery bank 14 and inverter board 30. The capacitor 18 may be particularly useful to ensure oversized batteries are not required to be installed in the battery bank 14.

During apparatus 10 operations, motor 16 converts the electrical energy, provided from the inverter board 30, into mechanical energy (power). To accomplish this effort, the motor 16 comprises two (2) rotors (not shown) that each produce the equivalent of 27V (approximately) of mechanical energy when rotating their corresponding (2) shaft 21, to deliver the mechanical energy. An example of a motor 16 for use in the apparatus circuit 10 would be, but is not limited to, a 120V ½ HP single phase split phase electric motor (such as model D12B2N4 available from the US Motors Industrial Electric Ac/Dc Motors Company). It should be understood that other types of motors may work in the apparatus 10, so long as they are able to deliver sufficient mechanical energy to the rest of the apparatus circuit 10. Moreover, a pulley 20 is joined (typically four (4) inches in diameter and mechanically joined) to each motor shaft 21.

A primary generator 22 (alternator) is located downstream from the motor pulley 20 and has a rotor part joined to a generator pulley 24 (typically mechanically joined). The generator pulley 24 is in mechanical connection with the motor pulley 20 via a power transmission belt 26 (typically a V-belt). As such, when the motor pulley 20 rotates, this mechanical energy is in turn transferred through rotation of the generator pulley 24 and rotor. The mechanical energy from the rotor is in turn converted to electrical energy by the self-exciting stator of the primary generator, which may be approximately 27V. The primary generator then in turn provides this electrical energy at its output to the negative terminal (voltage input) of the battery pack 14. The provided electrical energy is thus used to recharge the electrochemical cells of the battery pack 14. This allows the electrical energy to be returned and recycled through the apparatus circuit 10. An example of a primary generator 22 for use in the apparatus circuit 10 would be, but is not limited to, a CS144 Style Alternator (such as model 57806 GM CS144 Large Alternator 200A w/M10x1.5 Adj Flange available from the Powermaster Motorsports Company).

A secondary generator 28 (alternator) is located downstream from the motor pulley 20′. The secondary generator 28 also has a rotor part with pulley 24′ joined to it (typically mechanically joined). The generator pulley 24′ is also in mechanical connection with the motor pulley 20′ via power transmission belt 26′ (typically a V-belt). As shown, this configuration is similar to the rotor pulley configuration between the motor 16 and primary generator 22. However, in certain circumstances, these configurations may be different.

When the motor pulley 20′ rotates, this mechanical energy is in turn transferred through rotation of the generator pulley 24′ and rotor. The mechanical energy from the rotor is in turn converted to electrical energy by the self-exciting stator of the secondary generator 28, which may be approximately 27V. The secondary generator 28 is typically similar in design to the primary generator 22. However, in certain circumstances, the designs of these generators may be different to accomplish the needs of the load circuit 12. An example of a secondary generator 28 for use in the apparatus circuit 10 would also be, but is not limited to, a CS144 Style Alternator (such as model 57806 GM CS144 Large Alternator 200A w/M10x1.5 Adj Flange available from the Powermaster Motorsports Company).

The secondary generator 28 in turn provides electrical energy to one of the inputs of the inverter board 18. One of the outputs of the inverter board 18 is configured to provide a continuous flow of adapted electrical energy to the load circuit 12, which conforms to the load circuit 12 specifications, such as a pure sine wave. The inverter board 18 may have a 30V maximum voltage input and may deliver approximately 120V, typically around 10 kW, to the load circuit (anything above 3 kW may work). Another one of the inputs of the inverter board 18 is electrically connected to the negative terminal of the battery pack 18. A switch (not shown) may be installed on the inverter board 12, or on an electrical connection at one output of the inverter board 12, to interrupt the flow of electrical energy provided to the load circuit 12. The switch may be operated by a user of the apparatus circuit 10 or it may be operated by a sensing unit that ensures the flow of electrical energy provided to the load circuit 12 does not exceed its capacity. For ideal conditions of apparatus 10 use, the load circuit 12 should typically be a closed circuit and able to operate on the provided electrical energy with nominal energy loss through normal operations. A load circuit 12 may be, but is not limited to, infrastructure (e.g. a house or commercial building), industrial equipment (e.g. power tools or a fluid pump), or it may be a vehicle (e.g. an automobile, ship, or aircraft). It should be understood, in certain instances, the load circuit 12 may receive an additional flow of electrical energy from a secondary energy source (e.g. an outside electric power grid or additional battery) other than the apparatus circuit 10. In such instances, the apparatus circuit 10 may support the secondary energy source (not shown) or the secondary energy source may be used to support the apparatus circuit 10.

Depending on the circumstances, the primary generator 22 and secondary generator 28 may be physically stacked/interlocked on top of each other in a vertically oriented manner or they may be physically positioned/interlocked in series in a horizontally oriented manner. All components of the apparatus circuit 10 may be contained in a housing/casing (not shown), so as to physically confine the apparatus 10, protect its components from damage, waterproof the components of the apparatus circuit 10, allow the apparatus circuit 10 to be portable, etc. The components themselves and/or the electrical connections may even have their own individual housing/casing to enable the damage protection and/or waterproofing. The apparatus 10 may even be constructed to be confined to a light-weight back pack so as to allow the apparatus 10 to be portable in such a way that a user may move the apparatus 10 from one location to another with ease. As follows, this construction of the apparatus would be particularly useful in situations such as, but not limited to, military applications (i.e. for providing electrical energy to installations in remote base camps) or recreational camping activities (i.e. for providing energy to portable infrastructure such as tents). An example of a light-weight back pack would be, but is not limited to, a sling bag, tactical assault pack, and military-style duffle bag. The apparatus 10 may even further be installed on a wheeled utility cart (not shown) to allow the apparatus 10 to be portable.

It should be noted that the apparatus 10 components may each be grounded to prevent user contact with dangerous voltage if their electrical insulation fails as well as limit the build-up of static electricity in the component casings/frames. Such grounding should accrue minimal voltage loss during use of the apparatus 10.

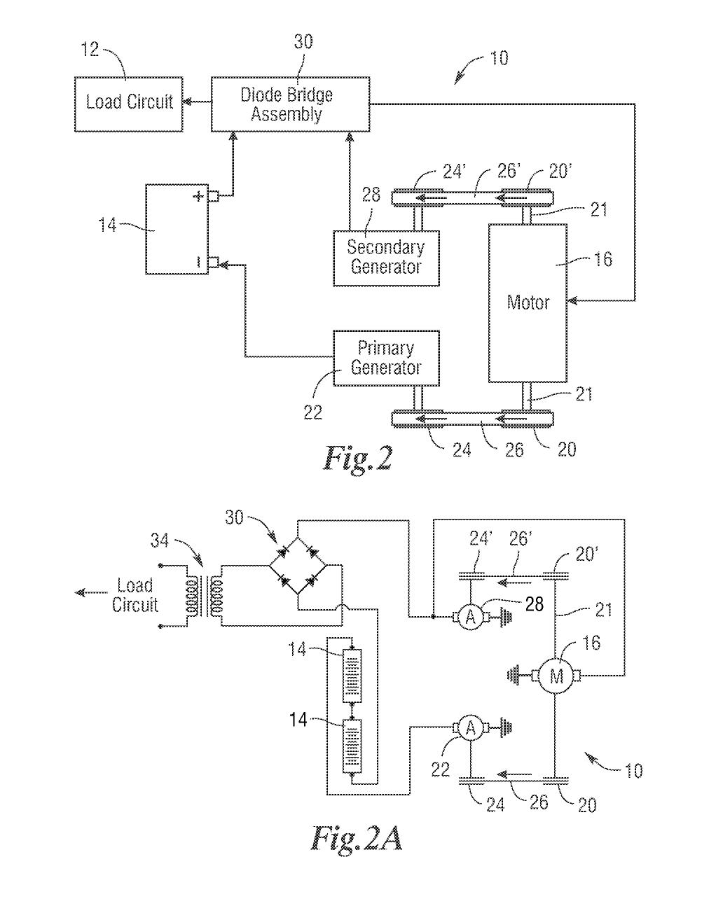

As shown in FIGS. 2 and 2A, when the load circuit 12 requires low wattage applications, current-conversion component 30 may be embodied as a bridge rectifier assembly. To accomplish this effort (similar to the exemplary inverter board discussed above), a 12V/120V step-up transformer 34 is placed in a parallel configuration to a 120 Hz diode bridge 30.

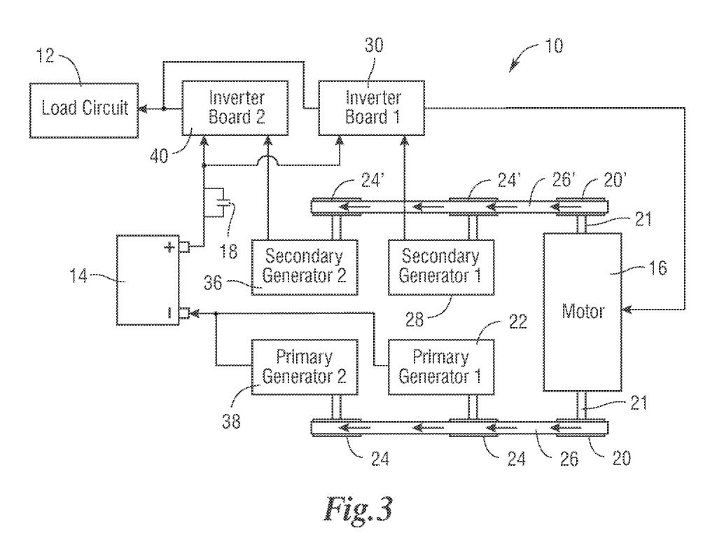

As shown in FIG. 3, to increase energy output, additional generators 36, 38 and at least one additional inverter board 40 (current-conversion component) may be installed within the apparatus 10. In this embodiment, secondary generator 28 and the additional secondary generator 36 are both located downstream from the motor pulley 20′. As such, the generator pulleys 24′ and 42′ are each in mechanical connection with the motor pulley 20′ via power transmission belt 26′. Secondary generator 28 is electrically connected to the inverter board 30. The additional secondary generator 36 is electrically connected to the additional inverter board 40. Each inverter board 30, 40 is electrically connected to the load circuit 12. The additional inverter board 40 may also be electrically connected to the terminal box of the motor 16 (not shown) so as to function in a similar manner as inverter board 30, discussed above.

To maintain electrical energy balance, an additional primary generator 38 maintains a sufficient amount of electrical energy is delivered back to the battery bank 14. Primary generator 22 and the additional primary generator 38 are both located downstream from the motor pulley 20. As such, the generator pulleys 24 and 42 are each in mechanical connection with the motor pulley 20 via power transmission belt 26. The primary generator 22 and the additional primary generator 38 each in turn provide electrical energy at their output to the negative terminal of the battery pack 14. It should be noted that the generators may be required to be stepped up sequentially to ensure there is no excessive charge of electrical energy delivered to the load circuit 12, at the beginning of apparatus 10 operations. One having skill will understand that tensioners may be implemented to ensure the power transmission belts 26, 26′ each remains tight. It should be understood that other embodiments of the apparatus 10 may include more than one additional primary and secondary generator. All generators are typically similar in design to each other. However, in certain circumstances, the design of one secondary generator/primary generator may be different from the other or the similar secondary generators may be different from the similar primary generators, to accomplish the needs of the load circuit 12. Moreover, the generators may be physically stacked/interlocked on top of each other in a vertically oriented manner or they may be physically positioned/interlocked in series in a horizontally oriented manner.

It should be understood the steps of the method presented herein do not necessarily have to be in the order in which it is presented. It is also understood that when an element is referred to as being “on”, “connected to/with”, or “coupled to/with” another element, the element can be directly on, connected to/with or coupled to/with the other element or intervening elements may also be present.

While the invention has been described with reference to preferred embodiments, it will be understood by those skilled in the art that various changes may be made and equivalents may be substituted for elements or components thereof to adapt to particular situations without departing from the scope of the invention. Therefore, it is intended that the invention not be limited to the particular embodiments disclosed as the best mode contemplated for carrying out this invention, but that the invention will include all embodiments falling within the scope and spirit of the following claims.

1. An apparatus for providing electrical energy for an extended period of time, said apparatus comprising:
a battery bank having a positive terminal and a negative terminal, said battery bank for generating a charge of electrical energy;
an inverter configured to be electrically connected said positive terminal and a secondary generator, an output of said inverter configured to be electrically connected to a motor and a load circuit;
said motor started by the charge of electrical energy generated from said battery bank, via said inverter, said motor for converting electrical energy into mechanical energy;
a primary generator configured to be mechanically connected to said motor, said primary generator for converting mechanical energy from said motor into electrical energy, said primary generator connected to said negative terminal and configured to provide electrical energy to said battery bank;
said secondary generator configured to be mechanically connected to said motor, said secondary generator for converting mechanical energy from said motor into electrical energy, said secondary generator connected to said inverter and configured to provide electrical energy thereto; and
wherein said inverter is configured to provide electrical energy to said motor and said load circuit.

2. (canceled)

3. (canceled)

4. The apparatus for providing electrical energy of claim 1 further comprising a switch to disconnect the flow of electrical energy to the load circuit.

5. The apparatus for providing electrical energy of claim 1 wherein said primary generator and said secondary generator are each an alternator having a self-exciting stator.

6. The apparatus for providing electrical energy of claim 1 wherein the mechanical connection between each said generator and said motor is a pulley and belt configuration.

7. The apparatus for providing electrical energy of claim 1 wherein the load circuit is a vehicle, infrastructure, or a power tool.

8. The apparatus for providing electrical energy of claim 1 wherein said battery bank is a plurality of deep-cycle batteries electrically connected in a series configuration.

9. The apparatus for providing electrical energy of claim 1 wherein said inverter is an inverter board.

10. The apparatus for providing electrical energy of claim 1 wherein said inverter is a bridge rectifier assembly.

11. The apparatus for providing electrical energy of claim 1 wherein said apparatus is portable.

12. An electrical energy providing circuit configured to provide electrical energy for an extended period of time to a load circuit, said circuit comprising:
a plurality of deep-cycle batteries electrically connected in a series configuration, said batteries can generate a charge of electrical energy;
an inverter board electrically connected at the input to one of said plurality of batteries and a secondary alternator, said inverter board electrically connected at the output to a motor and the load circuit;
said motor started by the charge of electrical energy generated from said plurality of batteries, said motor for converting electrical energy into mechanical energy;
a primary alternator having a self-exciting stator, said primary alternator is mechanically connected to said motor via a pulley and belt configuration, said primary alternator converts mechanical energy from said motor into electrical energy, said primary alternator electrically connected at the output to said plurality of batteries, said primary alternator provides electrical energy to one of said plurality of batteries;
a switch to disconnect the flow of electrical energy to the load circuit;
said secondary alternator having a self-exciting stator, said secondary alternator mechanically connected to said motor via an additional pulley and belt configuration, said secondary alternator converts mechanical energy from said motor into electrical energy, said secondary alternator provides electrical energy to said inverter board;
wherein said inverter board provides electrical energy to said motor and provides adapted electrical energy to said load circuit; and
said load circuit is closed and operates with nominal energy loss through normal operations.

13. The circuit for providing electrical energy of claim 12 further comprising an additional secondary alternator having a self-exciting stator, said additional secondary alternator mechanically connected to said motor via the additional pulley and belt configuration, said additional secondary generator converts the mechanical energy from said motor into electrical energy, said additional secondary generator provides electrical energy to an additional inverter board; and
wherein said additional inverter board provides adapted electrical energy to said load circuit.

14. The circuit for providing electrical energy of claim 13 further comprising an additional primary alternator having a self-exciting stator, said additional primary alternator mechanically connected to said motor via the pulley and belt configuration, said additional primary generator converts mechanical energy from said motor into electrical energy, said additional primary generator provides electrical energy to said plurality of batteries.

15. The circuit for providing electrical energy of claim 12 wherein the load circuit is a vehicle, infrastructure, or a power tool.

16. The circuit for providing electrical energy of claim 12 wherein said circuit is portable.
